(19) United States
(12) Patent Application Publication
(10) Pub. No.: US 2014/0368531 A1
(43) Pub. Date: Dec. 18, 2014

(54) DYNAMIC CONTRAST ENHANCEMENT USING DITHERED GAMMA REMAPPING

(71) Applicant: SYNAPTICS INCORPORATED, Santa Clara, CA (US)

(72) Inventor: Jeffrey A. SMALL, Rochester, NY (US)

(21) Appl. No.: 13/916,533

(22) Filed: Jun. 12, 2013

(51) Int. Cl. G09G 5/02

(52) U.S. Cl. CPC G09G 5/02
USPC 345/596; 345/581

(57) ABSTRACT

Embodiments of the present invention generally provide a processing system for a display device. The processing system includes a histogram circuit configured to process a first plurality of pixel values associated with a first image to generate a first histogram. The processing system further includes a boost circuit configured to analyze the first histogram to determine a first boost level. Additionally, the processing system includes an interpolation circuit configured to interpolate, based on the first boost level, between a first boost mapping and a second boost mapping to generate a first intermediate boost mapping. The interpolation circuit is further configured to determine a first plurality of boosted pixel values based on the first intermediate boost mapping.

### BACKGROUND OF THE INVENTION

1. Field of the Invention

Embodiments of the present invention generally relate to a system, device, and method for dynamically remapping pixel values of a display device.

2. Description of the Related Art

Display devices are widely used in a variety of electronic systems to provide visual information to a user. For example, display devices may be used to provide a visual interface to an electronic system, such as a desktop computer. Advancements in display technologies have enabled display devices to be incorporated into an increasing number of mobile applications, such as laptop computers, tablet computers, and mobile phones. In such applications, display devices are capable of providing high-resolution interfaces having relatively thin form factors.

In general, display devices are the largest energy consumer in a mobile device. For example, in many laptop computers and smartphones, the display device typically accounts for more than half of the energy consumed during a given charge-discharge cycle. Moreover, as mobile devices continue to move towards thinner and/or smaller form factors, battery sizes are being decreased, reducing the battery life of these devices. As such, there is a strong driving force in the industry towards decreasing the energy consumption of mobile display devices.

In devices which use liquid crystal display (LCD) technologies, a backlight draws a significant amount of energy, even when the device is displaying dark images. That is, an LCD panel typically produces dark images (e.g., a black screen) by blocking out the backlight. Consequently, a significant amount of energy consumed by the backlight may be wasted.

Therefore, there is a need in the art for a more efficient way of displaying images on a display device.

### SUMMARY OF THE INVENTION

Embodiments of the present invention generally provide a processing system for a display device. The processing system includes a histogram circuit configured to process a first plurality of pixel values associated with a first image to generate a first histogram. The processing system further includes a boost circuit configured to analyze the first histogram to determine a first boost level. Additionally, the processing system includes an interpolation circuit configured to interpolate, based on the first boost level, between a first boost mapping and a second boost mapping to generate a first intermediate boost mapping. The interpolation circuit is further configured to determine a first plurality of boosted pixel values based on the first intermediate boost mapping.

Embodiments of the present invention may also provide an electronic device. The electronic device includes a display device and a processing system coupled to the display device. The processing system is configured to process a first plurality of pixel values associated with a first image to generate a first histogram and analyze the first histogram to determine a first boost level. The processing system is further configured to interpolate, based on the first boost level, between a first boost mapping and a second boost mapping to generate a first intermediate boost mapping. Additionally, the processing system is configured to determine a first plurality of boosted pixel values based on the first intermediate boost mapping.

Embodiments of the present invention may also provide a method for processing an image. The method includes processing a first plurality of pixel values associated with a first image to generate a first histogram and analyzing the first histogram to determine a first boost level. The method further includes interpolating, based on the first boost level, between a first boost mapping and a second boost mapping to generate a first intermediate boost mapping. Finally, the method includes determining a first plurality of boosted pixel values based on the first intermediate boost mapping.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only embodiments of the invention and are therefore not to be considered limiting of its scope, for the invention may admit to other equally effective embodiments.

FIG. 1 is a block diagram of an exemplary display device in accordance with embodiments of the invention.

FIG. 2 illustrates normalized transmittance as a function of 8-bit grey levels in an ideal liquid crystal display (LCD) panel in accordance with embodiments of the invention.

FIG. 3 illustrates normalized transmittance as a function of 8-bit grey levels using boosted gamma curves in accordance with embodiments of the invention.

FIG. 4 illustrates the voltage applied to an LCD panel as a function of 8-bit grey levels using boosted gamma curves in accordance with embodiments of the invention.

FIG. 5 illustrates a parabolic transmittance boost function in accordance with embodiments of the invention.

FIG. 6 illustrates a graph for remapping input grey levels to output grey levels in accordance with embodiments of the invention.

FIG. 7 illustrates a partial block diagram of the processing system of FIG. 1 in accordance with embodiments of the invention.

FIG. 8 is a flow diagram of a method for processing an image to boost grey levels in accordance with embodiments of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention generally provide a technique for dynamically modifying pixel values (e.g., grey levels) associated with video frames. Input grey levels associated with a video frame may be processed to generate a histogram, which is further analyzed to determine a boost level. The boost level may then be used to generate output grey levels, for example, by interpolating between a maximum boost level and a minimum boost level. Advantageously, modifying grey levels based on a boost level may be used to increase the transmissivity associated with a video frame, enabling the brightness of a liquid crystal display (LCD) backlight to be reduced in order to decrease energy consumption.

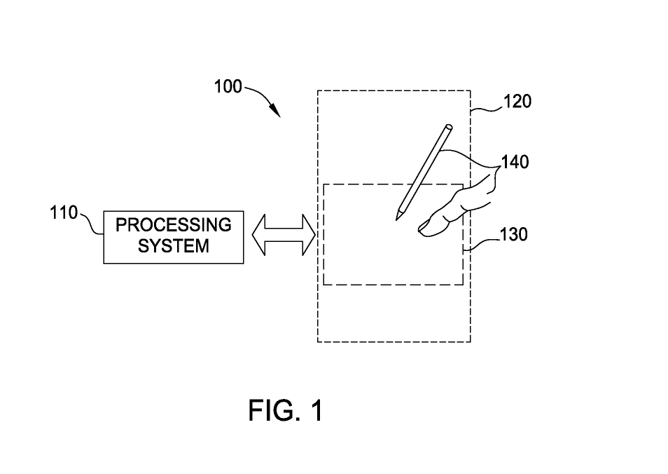

Turning now to the figures, FIG. 1 is a block diagram of an exemplary display device 100 in accordance with embodiments of the invention. The display device 100 comprises a display region 120 configured to display images to a user and an optional input sensing region 130 configured to detect user input. Example input objects 140 include fingers and styli, as shown in FIG. 1. The display region 120 and the input sensing region 130 may share physical elements. For example, some embodiments may utilize some of the same electrical components for displaying and sensing. In some embodiments, the display device 100 comprises a touch screen display interface, and the input sensing region 130 overlaps at least part of an active area of a display region 120. The input sensing region 130 may comprise substantially transparent sensor electrodes overlaying the display screen and provide a touch screen interface.

A processing system 110 may be included as part of the display device 100. The processing system 110 is configured to operate the hardware of the display device 100 to process display images (e.g., video frames) and drive display signals to display elements, such as pixels/sub-pixels disposed in the display region 120. The processing system 110 comprises parts of, or all of, one or more integrated circuits (ICs) and/or other circuitry components. For example, the processing system 110 may include a display driver (DDI) comprising display circuitry for driving display signals to refresh sub-pixels in the display region 120. In some embodiments, the processing system 110 also comprises electronically-readable instructions, such as firmware code, software code, and the like. In some embodiments, components of the processing system 110 are disposed in and/or integrated with the display region 120, such as on display substrates of the display device 100. In other embodiments, components of processing system 110 are physically separate from components in the display region 120. For example, the display device 100 may be coupled to a desktop computer, and the processing system 110 may include software configured to run on a central processing unit of the desktop computer and one or more ICs (perhaps with associated firmware) separate from the central processing unit. As another example, the display device 100 may be physically integrated in a mobile device, such as a smartphone or tablet, and the processing system 110 may comprise circuits and firmware that are part of a main processor of the mobile device. In some embodiments, the processing system 110 is dedicated to operating the display device 100. In other embodiments, the processing system 110 also performs other functions, such as sensing input devices 140, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as display screens and sensor electrodes, data processing modules for processing image data such as pixel values and histograms, and modules for interpolating grey level mappings and determining boost levels. Further example modules include sensor operation modules configured to operate sensing element(s) in the input sensing region 130 to detect input devices 140.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

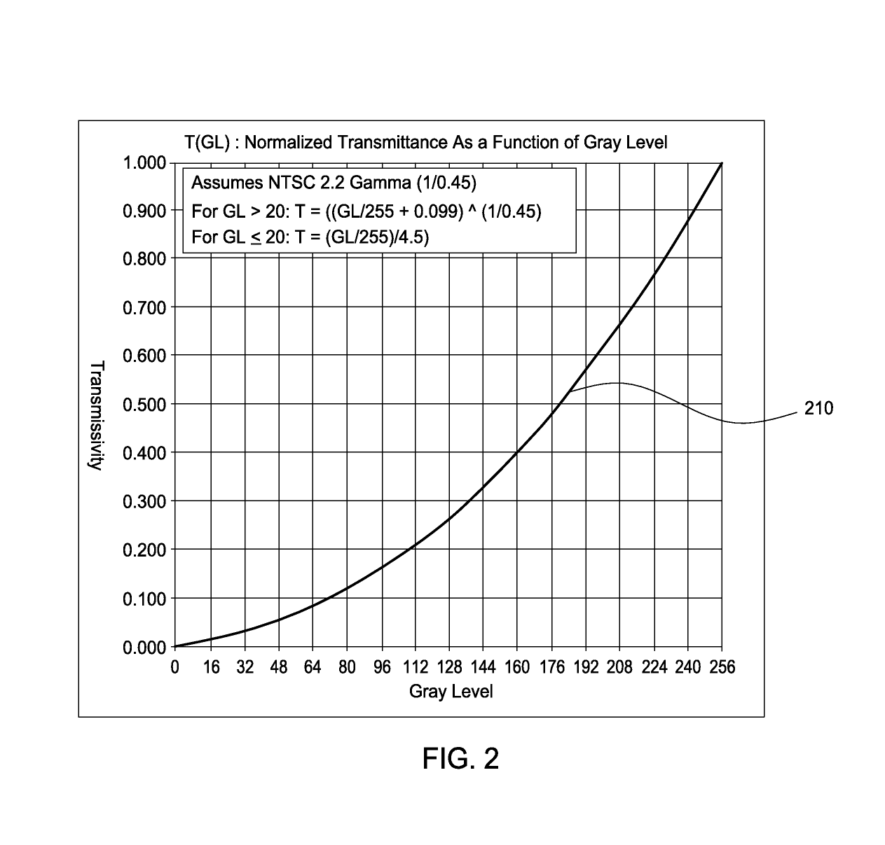

As used in this document, the term “display device” broadly refers to any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. Some non-limiting examples of display devices include displays used in smartphones, tablets, laptop computers, desktop computer monitors, televisions, cellular telephones, e-book readers, personal digital assistants (PDAs), and the like. Although the operation of an exemplary display device—an LCD display device—is described below with respect to FIGS. 2-8, the techniques described herein may be used with any type of display device, such as those described above.

FIG. 2 illustrates normalized transmittance as a function of 8-bit grey levels in an ideal liquid crystal display (LCD) panel in accordance with embodiments of the invention. As shown, the fraction of light that passes through an LCD panel is varied as a function of grey level in accordance with a gamma curve 210. For example, at a grey level of 255, 100% of light is permitted to pass through an ideal LCD panel, while, at a grey level of 0, no light is permitted to pass through an ideal LCD panel. In addition, grey levels between 0 and 255 are mapped to transmissivities in a non-linear manner. For example, at a grey level of 128, approximately 26% of light is permitted to pass through an ideal LCD panel.

Each video frame displayed by a display device 120 includes pixels having a certain distribution of grey levels. Video frames which include relatively bright image content generally include more pixels having high grey levels (e.g., above 128), while video frames which include relatively dark image content generally include more pixels having low grey levels (e.g., below 128). During operation of a typical LCD panel, the backlight brightness is held at a substantially constant level and is not varied as a function of pixel grey levels. Accordingly, in order to display dark images with a typical LCD panel, a significant portion of the light produced by the backlight must be blocked by the LCD panel. For example, a video frame which includes dark image content may consist of pixels having a distribution of grey levels from 0 to 160, with little or no pixels in the video frame having a grey level that falls within the range of 161-255. Consequently, in a typical LCD panel, a significant portion of the dynamic range (e.g., grey levels 161-255) may not be utilized when displaying dark image content. Furthermore, a significant amount of energy may be wasted to provide illumination (e.g., via the backlight) that is subsequently blocked by the LCD panel.

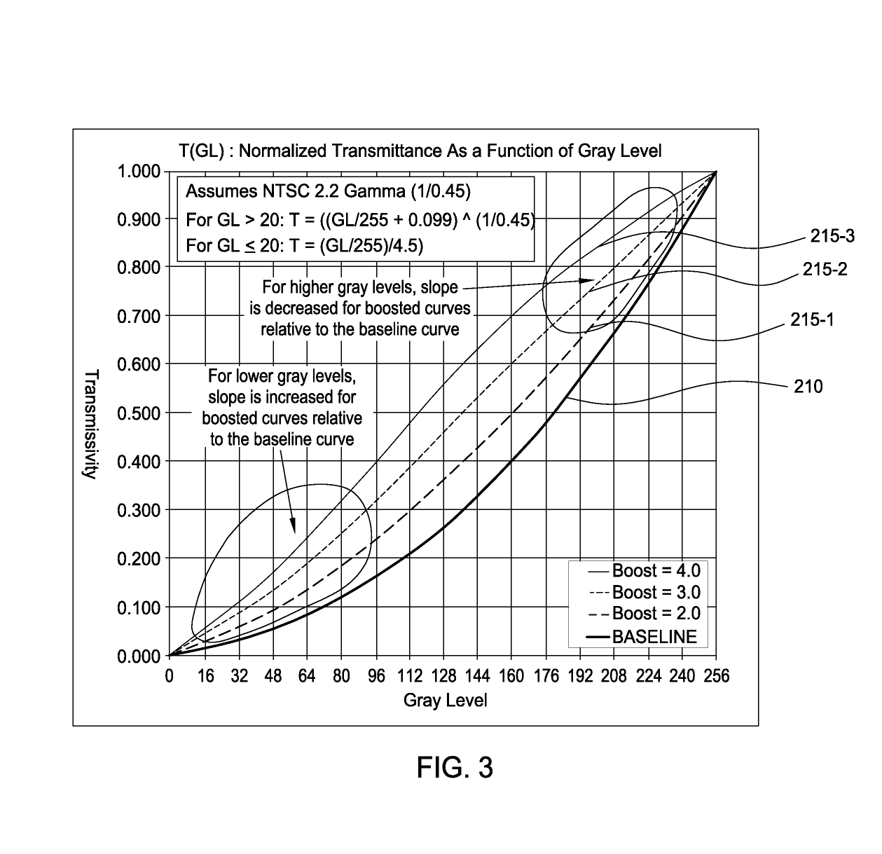

Thus, in order to better utilize the dynamic range of a display device, the pixel grey levels of relatively dark images may be boosted (e.g., increased). Additionally, in order to reduce the amount of energy expended by the display device, the brightness of the backlight may be adjusted based on the boost level applied to the grey levels, as described in further detail below with reference to FIGS. 3-6.

Dynamic Contrast Enhancement Using Dithered Gamma Remapping

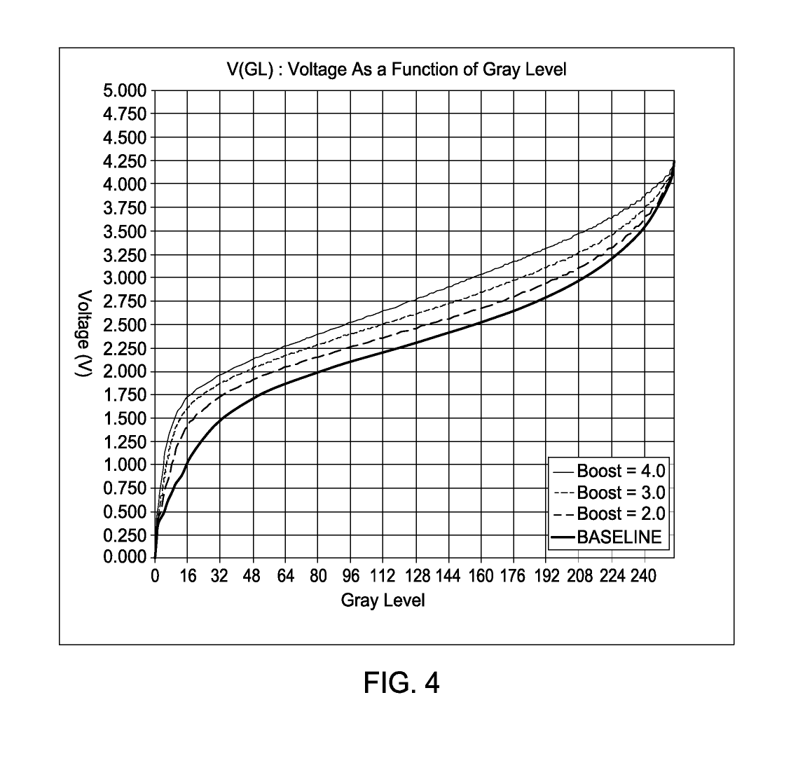

FIG. 3 illustrates normalized transmittance as a function of 8-bit grey levels using boosted gamma curves 215 in accordance with embodiments of the invention. As shown, each input grey level may be mapped to an output grey level based on a boosted gamma curve 215-1, 215-2, 215-3 (collectively “215”) such that each input grey level is associated with a higher transmissivity than specified by the initial (unboosted) gamma curve 210. For example, when applying boosted gamma curve 215-1 to the pixel values of a video frame, a pixel having an input grey level of 128 is mapped to an output grey level of 152, boosting the transmissivity of the pixel from approximately 26% to approximately 36%. In another example, when applying boosted gamma curve 215-3, a pixel having an input grey level of 128 is mapped to an output grey level of 189, boosting the transmissivity of the pixel from approximately 26% to approximately 55%. As such, after remapping input grey levels to output grey levels, the voltage applied to a pixel at a given input grey level may be modified to increase the transmissivity pixel, as described below with respect to FIG. 4.

FIG. 4 illustrates the voltage applied to an LCD panel as a function of 8-bit grey levels using boosted gamma curves 215 in accordance with embodiments of the invention. As shown, modifying pixel grey levels based on a boost level may alter the voltage applied to a pixel/sub-pixel of the LCD panel. For example, when applying boosted gamma curve 215-1 to the pixel values of a video frame, the voltage applied to a pixel having an input grey level of 128 is boosted from approximately 2.32 V to approximately 2.48 V, the voltage corresponding to an output grey level of 152. In another example, when applying boosted gamma curve 215-3, the voltage applied to a pixel having an input grey level of 128 is boosted from approximately 2.32 V to approximately 2.78 V, the voltage corresponding to an output grey level of 189.

In various embodiments, by remapping input grey levels to output grey levels—instead of continuously remapping grey levels to voltages—latency associated with switching between boost levels may be significantly reduced. For example, remapping grey levels to pixel voltages may require the processing system 110 to continuously modify and update register values within the processing system 110, decreasing response times when switching between boost levels. However, by remapping input grey levels to output grey levels, registers associated with grey level-to-voltage mappings are not modified, enabling the processing system 110 to quickly switch between different boost levels. In one embodiment, remapping input grey levels to output grey levels enables the processing system 110 to switch between boost levels on a frame-to-frame basis within a single video scene.

Remapping input grey levels to output grey levels in the manner described above may be performed to increase the overall transmissivity of an LCD panel, enabling the brightness and energy consumption of the backlight to be decreased without significantly affecting image quality. For example, modifying grey levels to increase the transmissivity of the LCD panel by 20% may allow the backlight brightness to be decreased by 20%, reducing energy consumption while presenting essentially the same image to the viewer. Further, modifying grey levels may increase image contrast in dark regions of the display region 120. For example, as shown in FIG. 3, at low grey levels (e.g., below 150), the slopes of the boosted gamma curves 215 are increased as compared to the slope of the initial gamma curve 210, resulting in increased image contrast.

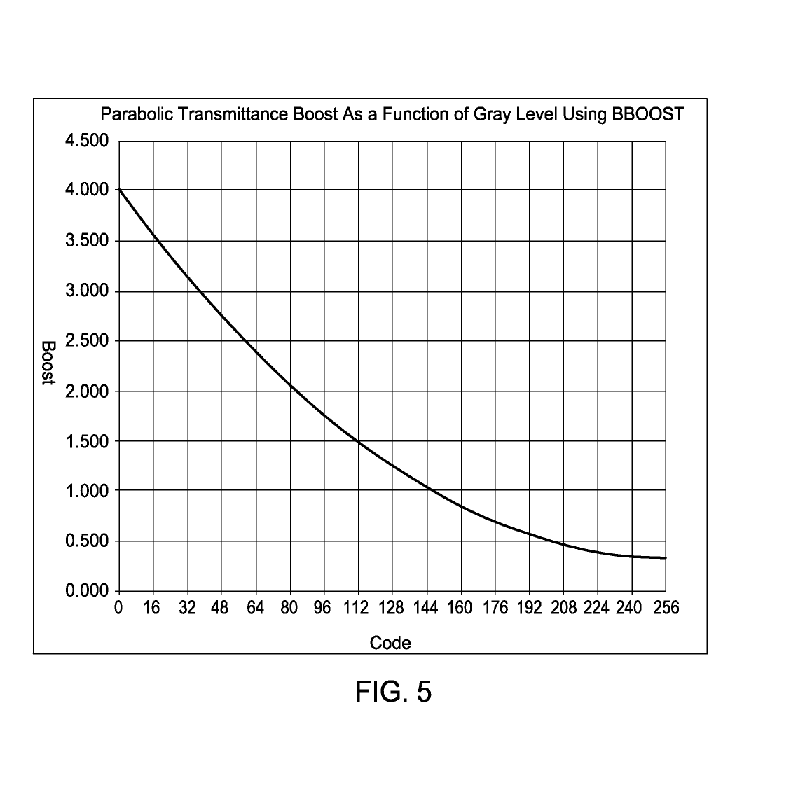

An exemplary function for remapping grey levels is shown in FIG. 5, which illustrates a parabolic transmittance boost function in accordance with embodiments of the invention. As shown, the transmittance boost function may be applied to increase the slope of the initial gamma curve 210 at grey levels below approximately 150. Increasing the slope improves image quality because it increases the perceived contrast. Increasing the slope also may raise the transmittance. For example, the transmittance boost function may be applied to increase the slope of the transmittance associated with a grey level of 60 by a factor of approximately 2.5 and the slope of the transmittance associated with a grey level of 112 by a factor of approximately 1.5. However, in order to maintain the endpoints of the initial gamma curve, at higher grey levels (e.g., 150 or higher), the slopes of the boosted gamma curves 215 may be decreased, as shown in FIGS. 3 and 5. Consequently, the exemplary boosted gamma curves 215 described herein may decrease image contrast at high grey levels. As such, pixel values associated with a video frame may be analyzed to determine whether a boosted gamma curve 215 should be applied to the video frame. Other similar functions may be used to remap grey levels. In general, similar functions should increase the slope of the transmittance for darker input grey levels and decrease the slope of the transmittance for brighter input grey levels.

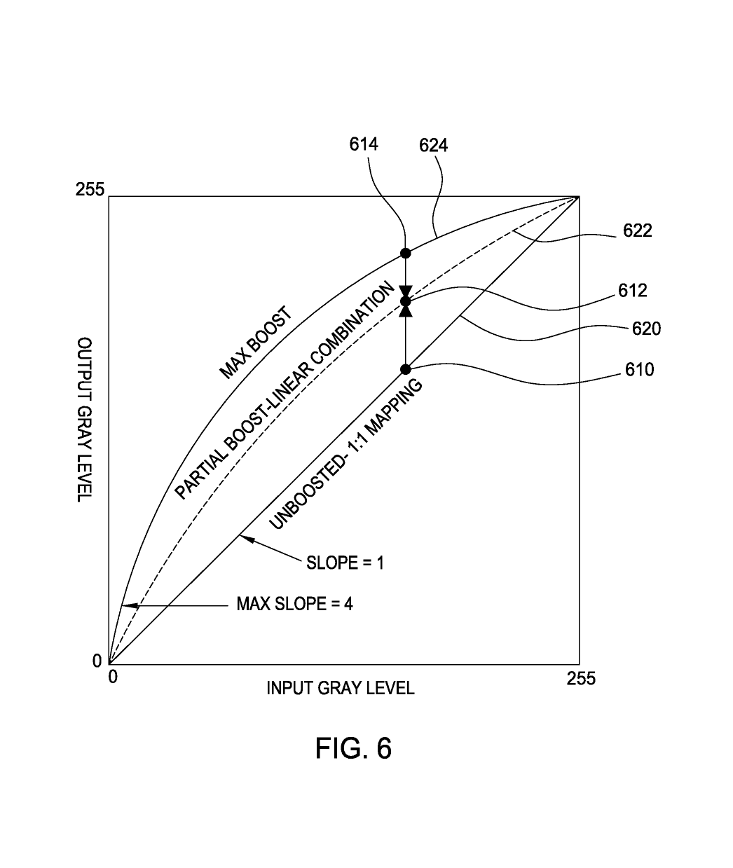

In various embodiments, pixel values associated with a video frame may be processed to generate a histogram. The histogram then may be analyzed to determine an appropriate boost level or to determine that the initial gamma curve 210 should not be boosted. In general, in order to avoid decreasing the contrast in bright regions of a video frame, a higher boost level may be applied to darker images, while a lower boost level (or no boost) may be applied to brighter images. In one embodiment, to determine an appropriate boost level, the frequency of pixel values (e.g., grey levels, luminance values, RGB values, and the like) may be counted and sorted into a number of bins, where each bin corresponds to a range of levels/values to determine a brightness (or darkness) metric. For example, pixel grey levels may be sorted into 8 bins having grey level ranges of 0-31, 32-63, 64-95, etc. A boost level then may be determined based on the number of pixels associated with one or more of the bins. For example, a boost level may be determined based on the number of pixels associated with the bin that represents the highest grey levels (e.g., a grey level range of 224-255). In another example, a boost level may be determined by comparing each bin to one or more pixel count thresholds. Any number of bins and/or discrete boost levels may be used to analyze and modify pixel values of a video frame. Moreover, the boost level may be continuously varied by interpolating between a maximum boost level and a minimum boost level, enabling the processing system 110 to quickly switch between different boost levels on frame-to-frame basis. An exemplary interpolation technique is described below with respect to FIG. 6.

FIG. 6 illustrates a graph for remapping input grey levels to output grey levels in accordance with embodiments of the invention. As shown, the boost level applied to each input grey level may be determined by calculating an intermediate boost mapping (e.g., output grey level 612) by interpolating a maximum boost mapping 624 (e.g., maximum grey level 614) and a minimum boost mapping 620 (e.g., unboosted grey level 610). For example, if a boost level of 25% is to be applied to a pixel grey level, then the output grey level may be calculated as a linear combination of the grey level associated with the minimum boost level (BLₘᵢₙ) and the grey level associated with the maximum boost level (BLₘₐₓ), as shown below in Equation 1. Additionally, if a boost level of 90% is to be applied to a pixel grey level, then a linear combination may be calculated according to Equation 2, provided below. In various embodiments, the boost mappings 620 and 624 may be stored in a fixed lookup table for each boost mapping, enabling the processing system 110 to efficiently interpolate between boost levels (e.g., unboosted grey level 610 and maximum grey level 614).

BLₘᵢₙ×0.75+BLₘₐₓ×0.25 (Eq. 1)

BLₘᵢₙ×0.10+BLₘₐₓ×0.90 (Eq. 2)

A boost level may be determined by analyzing pixel values associated with a video frame. As described above, a higher boost level may be selected for darker images, and a lower boost level may be selected for brighter images. In general, any number of discrete boost levels may be calculated based on the minimum boost level BLₘᵢₙ and the maximum boost level BLₘₐₓ. In one embodiment, pixel values associated with a video frame may be analyzed (e.g., using a histogram) to determine an 8-bit boost level, such that the processing system 110 is able to select between 256 discrete boost levels stored in a lookup table. Further, the backlight brightness of the LCD panel may be varied as a function of boost level. Thus, by enabling the processing system 110 to continuously switch between 256 different boost levels, the boost level and the brightness of the backlight may be gradually varied between consecutive video frames (e.g., within a single scene) in a manner that is substantially imperceptible to the user.

In other embodiments, the processing system 110 may use a scene change algorithm to detect when the next video frame belongs to a different scene. The boost level and the brightness of the backlight may then be switched starting with the first video frame of the next scene such that the user is less likely to perceive a change in gamma when switching between boost levels.

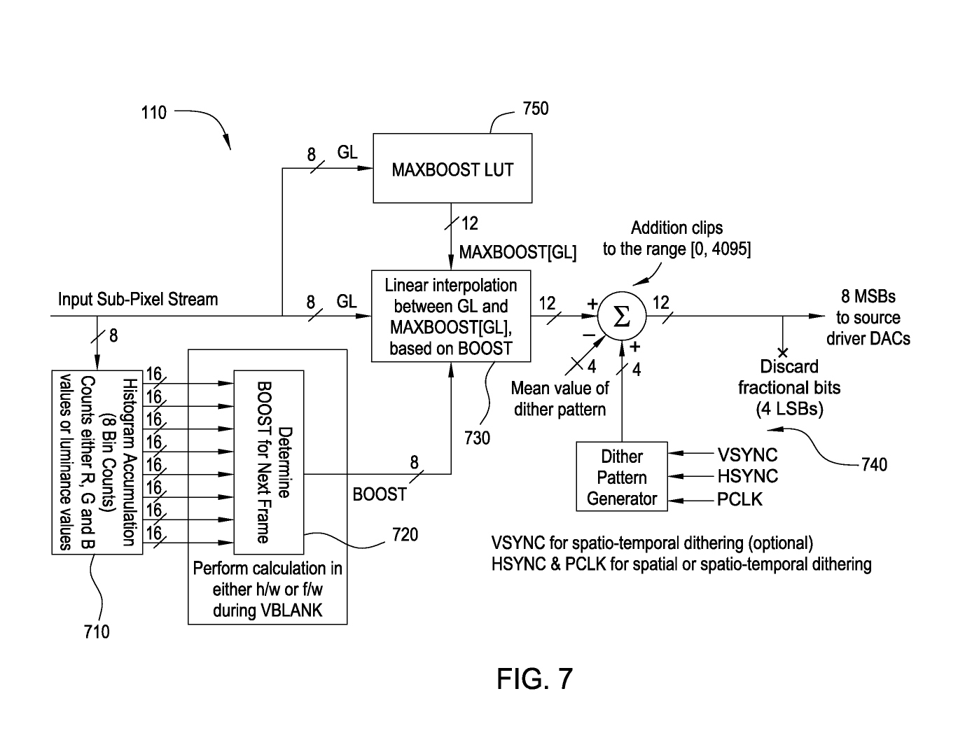

Although the above techniques are described as being performed by calculating linear combinations of grey levels, any mathematical technique for averaging, interpolating, combining, etc. pixel values may be used to determine output grey levels and/or boost levels. Moreover, the techniques described herein may be implemented using any type of general processor, dedicated processor, application-specific integrated circuit (ASIC), etc. that is associated with, or separate from, the processing system 110. Exemplary processing circuits for remapping input grey levels to output grey levels are described below with respect to FIG. 7.

FIG. 7 illustrates a partial block diagram of the processing system 110 of FIG. 1 in accordance with embodiments of the invention. The processing system 110 includes a histogram circuit 710 configured to analyze and bin input grey levels and a boost circuit 720 configured to determine a boost level based on pixel counts associated with one or more of the grey level bins. The processing system 110 further includes an interpolation circuit 730 configured to interpolate between boost levels and a dither circuit 740 configured to generate and apply a dither pattern to grey levels.

As shown, the histogram circuit 710 receives 8-bit pixel values (e.g., sub-pixel values) and sorts the sub-pixel values into 8 bins, each of which corresponds to a range of 32 sub-pixel values. The sub-pixel values may include luminance values and/or red, green, and/or blue (ROB) values. In other embodiments, input sub-pixel values may be specified by 6-bit values, 10-bit values, etc. and may be sorted into any desired number of bins, each of which corresponds to a range of sub-pixel values.

Next, the histogram circuit 710 transmits to the boost circuit 720 a sub-pixel count associated with each bin. Sub-pixel counts may be transmitted to the boost circuit 720 using 16-bit values (e.g., 16-bit floating point values). The boost circuit 720 receives and analyzes the sub-pixel counts to determine a boost level and transmits the boost level to the interpolation circuit 730. In one embodiment, the boost level is an 8-bit value (i.e., 0 to 255). A look-up table 750 converts the input sub-pixel values into maximally boosted sub-pixel values. The interpolation circuit 730 receives the boost level, the input sub-pixel values, and the maximally boosted sub-pixel values. The interpolation circuit 730 then interpolates, based on the boost value, between the input sub-pixel values and the maximally boosted sub-pixel values to determine output sub-pixel values. For example, when the interpolation circuit 730 receives a boost level of 63 (i.e., 25% boost) from the boost circuit 720, interpolation may be performed according to Equation 1, reproduced above.

In various embodiments, in order to reduce the incidence and/or mitigate the effects of remapping multiple input sub-pixel values to a single output sub-pixel value, sub-pixel values may be specified using 12-bit values during interpolation. The resulting 12-bit values may then be dithered, and the 4 least significant bits (LSBs) may be discarded prior to transmitting the sub-pixel values to a digital-to-analog converter (DAC) for display. Dithering output sub-pixel values may reduce or eliminate flat spots and contours in the resulting video frame caused by remapping two or more input sub-pixel values to a single output sub-pixel value. In other embodiments, the 12-bit values may be outputted to a 12-bit DAC. In still other embodiments, the 2 LSBs may be discarded and the resulting 10-bit values may be outputted to a 10-bit DAC with or without applying a dither pattern to the 10-bit values.

Dithering may be performed by calculating output sub-pixel values with 12 bits of precision (e.g., Q8.4) and then adding dithering noise to reduce image contouring. To add dithering noise, a dither pattern may be generated by the dither circuit 740 and added to the sub-pixel values. The mean value of the dither pattern may then be subtracted from the sub-pixel values to prevent the dither pattern from significantly increasing the brightness of the video frame. In one embodiment, the dither pattern may be a spatio-temporal dither pattern generated based on a frame rate signal, a line rate signal, and/or a pixel rate signal. For example, the dither pattern may be generated based on a vertical sync (VSYNC) signal, a horizontal sync (HSYNC) signal, and/or a pixel clock (PCLK) signal associated with the display device 100. After adding dithering noise, the 4 LSBs (e.g., the fractional bits) may be discarded, and the resulting 8-bit sub-pixel values may be transmitted to a DAC for conversion and display.

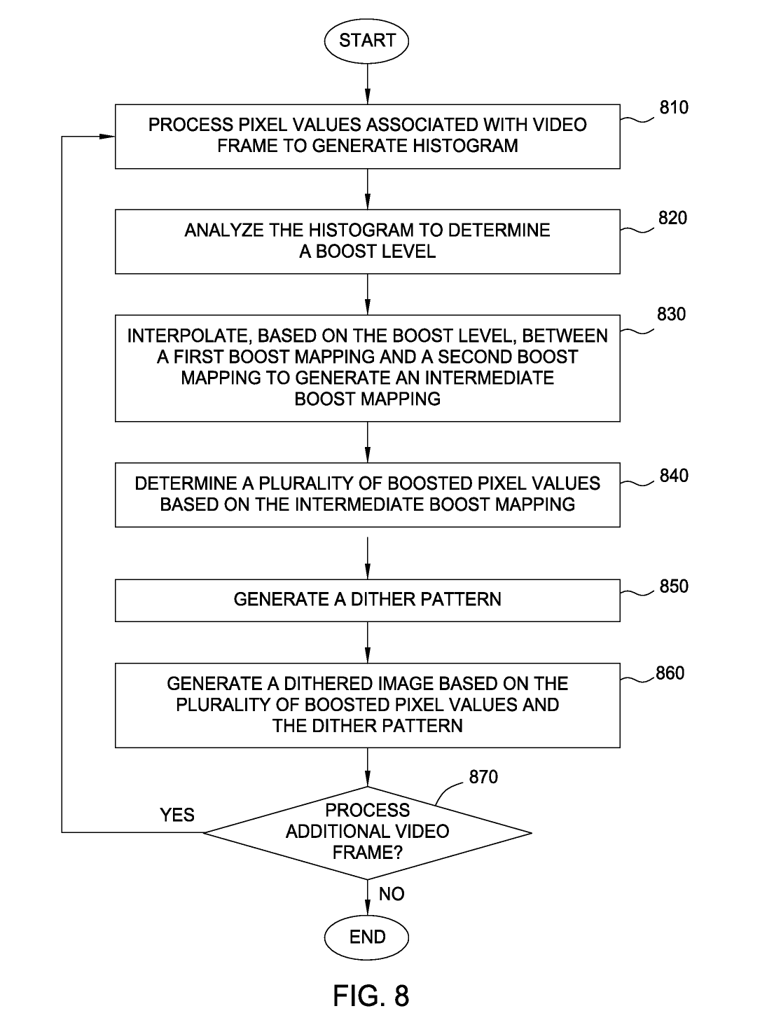

FIG. 8 is a flow diagram of a method 800 for processing an image to boost grey levels in accordance with embodiments of the invention. Although the method 800 is described in conjunction with FIGS. 1 and 7, persons skilled in the art will understand that any system configured to perform the method, in any appropriate order, falls within the scope of the present invention.

The method 800 begins at step 810, where pixel values (e.g., sub-pixel grey levels) associated with a video frame are processed by the histogram circuit 710 to generate a histogram. At step 820, the histogram is analyzed by the boost circuit 720 to determine a boost level. Next, at step 830, an intermediate boost mapping is generated by the interpolation circuit 730 by interpolating between a first boost mapping (e.g., a minimum boost mapping) and a second boost mapping (e.g., a maximum boost mapping) based on the boost level. At step 840, a plurality of boosted pixel values are determined based on the intermediate boost mapping. For example, the plurality of boosted pixel values may be determined based on a linear combination of the first boost mapping and the second boost mapping. In one embodiment, the intermediate boost mapping may be applied to boost pixel values associated with the current video frame (i.e., the video frame with which the histogram is generated). In other embodiments, the intermediate boost mapping may be applied to boost pixel values associated with a subsequent video frame, such as the next consecutive video frame. For example, in such embodiments, a first plurality of pixel values associated with the current video frame may be processed to determine an intermediate boost mapping, and the intermediate boost mapping may be applied to boost a second plurality of pixel values associated with the next video frame.

At step 850, a dither pattern is optionally generated by the dither circuit 740. The dither circuit 740 then may generate a dithered image based on the plurality of boosted pixel values and the dither pattern at step 860. Finally, at step 870, the processing system 110 determines whether an additional video frame is to be processed. If an additional video frame is to be processed, then the method returns to step 810, where pixel values are processed to generate a histogram. If no additional video frames are to be processed, then the method ends.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. A processing system for a display device, the processing system comprising:
a histogram circuit configured to process a first plurality of pixel values associated with a first image to generate a first histogram;
a boost circuit configured to analyze the first histogram to determine a first boost level; and
an interpolation circuit configured to:
interpolate, based on the first boost level, between a first boost mapping and a second boost mapping to generate a first intermediate boost mapping; and
determine a first plurality of boosted pixel values based on the first intermediate boost mapping.

2. The processing system of claim 1, wherein the first plurality of pixel values comprise luminance values.

3. The processing system of claim 1, wherein the first plurality of pixel values comprise red, green, and blue (RGB) values.

4. The processing system of claim 1, wherein the first boost mapping is associated with a minimum boost level and the second boost mapping is associated with a maximum boost level.

5. The processing system of claim 1, further comprising a dither circuit configured to:
generate a dither pattern; and
generate a dithered image based on the first plurality of boosted pixel values and the dither pattern.

6. The processing system of claim 5, wherein the dither pattern is a spatio-temporal dither pattern that is based on at least one of a frame rate signal, a line rate signal, and a pixel rate signal.

7. The processing system of claim 5, wherein generating the dithered image further comprises discarding one or more least significant bits (LSB) associated with one or more boosted pixel values included in the first plurality of boosted pixel values.

8. The processing system of claim 1, wherein the boost circuit is configured to determine a different boost level for each frame included in a plurality of consecutive frames included in a scene, and the interpolation circuit is configured to generate a different intermediate boost mapping for each frame included in the plurality of consecutive frames included in the scene.

9. The processing system of claim 8, wherein the interpolation circuit is further configured to determine the first plurality of boosted pixel values based on a second plurality of pixel values associated with a second image, wherein the first image and the second image are consecutive frames included in the scene.

10. An electronic device, the electronic device comprising:
a display device; and
a processing system coupled to the display device, the processing system configured to:
process a first plurality of pixel values associated with a first image to generate a first histogram;
analyze the first histogram to determine a first boost level;
interpolate, based on the first boost level, between a first boost mapping and a second boost mapping to generate a first intermediate boost mapping; and
determine a first plurality of boosted pixel values based on the first intermediate boost mapping.

11. The electronic device of claim 10, wherein the first plurality of pixel values comprise luminance values.

12. The electronic device of claim 10, wherein the first boost mapping is associated with a minimum boost level and the second boost mapping is associated with a maximum boost level.

13. The electronic device of claim 10, wherein the processing system is further configured to:
generate a dither pattern; and
generate a dithered image based on the first plurality of boosted pixel values and the dither pattern.

14. The electronic device of claim 13, wherein the dither pattern is a spatio-temporal dither pattern that is based on at least one of a frame rate signal, a line rate signal, and a pixel rate signal.

15. The electronic device of claim 13, wherein generating the dithered image further comprises discarding one or more least significant bits (LSB) associated with one or more boosted pixel values included in the first plurality of boosted pixel values.

16. The electronic device of claim 10, wherein the processing system is configured to determine a different boost level for each frame included in a plurality of consecutive frames included in a scene, and generate a different intermediate boost mapping for each frame included in the plurality of consecutive frames included in the scene.

17. The electronic device of claim 16, wherein the processing system is further configured to determine the first plurality of boosted pixel values based on a second plurality of pixel values associated with a second image, wherein the first image and the second image are consecutive frames included in the scene.

18. A method for processing an image, the method comprising:
processing a first plurality of pixel values associated with a first image to generate a first histogram;
analyzing the first histogram to determine a first boost level;
interpolating, based on the first boost level, between a first boost mapping and a second boost mapping to generate a first intermediate boost mapping; and
determining a first plurality of boosted pixel values based on the first intermediate boost mapping.

19. The method of claim 18, wherein the first plurality of pixel values comprise luminance values.

20. The method of claim 18, wherein the first boost mapping is associated with a minimum boost level and the second boost mapping is associated with a maximum boost level.

21. The method of claim 18, further comprising:
generating a dither pattern; and
generating a dithered image based on the first plurality of boosted pixel values and the dither pattern.

22. The method of claim 18, further comprising:
determining a different boost level for each frame included in a plurality of consecutive frames included in a scene; and
generating a different intermediate boost mapping for each frame included in the plurality of consecutive frames included in the scene.

23. The method of claim 22, further comprising determining the first plurality of boosted pixel values based on a second plurality of pixel values associated with a second image, wherein the first image and the second image are consecutive frames included in the scene.
